(19) United States
(12) Patent Application Publication
(10) Pub. No.: US 2017/0258048 A1
(43) Pub. Date: Sep. 14, 2017

(54) ELECTRIC DEHORNING APPLIANCE HAVING A HEATED BLADE CIRCULAR OVER 360°

(71) Applicant: CBHF INDUSTRIE, Chauvigny (FR)

(72) Inventor: Pascal Fonchain, Bonnes (FR)

(73) Assignee: CBHF INDUSTRIE, Chauvigny (FR)

(21) Appl. No.: 15/510,873

(22) PCT Filed: Sep. 8, 2015
(86) PCT No.: PCT/FR2015/052375

§ 371 Date: Mar. 13, 2017

(30) Foreign Application Priority Data
Sep. 12, 2014 (FR) 1458591

(51) Int. Cl. A01K 17/00

(52) U.S. Cl. CPC A01K 17/00

(57) ABSTRACT

An electric dehorning appliance includes a heated element having an annular heated blade forming an electrical resistance supplied by an electrical supply. The heated blade is electrically connected to the electrical supply by a pair of electrical connection elements. The heated blade extends in a circular fashion over 360° and is coupled to two diametrically opposed rigid electrical connection tabs.

### CROSS-REFERENCE TO RELATED APPLICATIONS

This Application is a Section 371 National Stage Application of International Application No. PCT/FR2015/052375, filed Sep. 8, 2015, the content of which is incorporated herein by reference in its entirety, and published as WO 2016/038290 on Mar. 17, 2016, not in English.

### FIELD OF THE DISCLOSURE

The field of the invention is that of the design and manufacture of equipment for rearing cattle. More precisely, the invention relates to an appliance for dehorning farm animals, and in particular but not exclusively for dehorning cattle.

### BACKGROUND OF THE DISCLOSURE

In the field of the invention, it is conventional to remove the horns from horned animals, to prevent risks of injuries liable to be caused by the animals to each other, or by the animals to humans.

Naturally the dehorning technique is mainly practiced in cattle rearing, but may also be transposed to other types of rearing of animals with horns, with simple functional adaptations and/or modifications of the operating parameters.

Currently, dehorning is traditionally practiced, in cattle raising, in the first three weeks after the birth of the calves, in order preferably to act at a stage where the horns have not yet grown and are still in the core state. The cores are visible once they have passed through the hide of the animal, but early dehorning is intended to reach them just before they have passed through the hide of the animal in order to stop the growth of the cores.

Among existing dehorning techniques, there is one that consists of applying a heated element around the core, with a view to destroying any blood irrigation of the core, and consequently to stop growth thereof.

The patent document under the number FR-2 951 612 describes an electric dehorning appliance corresponding to this technical approach.

According to the technique described by this document, the device takes the form of a portable electrical appliance in the form of a gun, part of which constitutes the handle and the other part the body of the appliance carrying at its end a dehorning head having an annular heated element. The heated element has a circular blade, forming the active part intended to burn the periphery of the core, this circular blade extending between two ends forming between them an angular separation of around ten degrees, a connection tab extending from each end of the circular blade.

Such a choice of design actually tends to be required so that the heated blade can resemble an ohmic resistance extending between two terminals.

With such a device, the user applies the circular heated blade to the core, through the hide, or not, and transmits to the handle of the appliance a rotation movement able to rotate the circular blade about the core, to burn the angular portion extending between the ends of the circular blade and thus to apply the burn all around the core.

In practice, it proves that the action for applying the burn exerted by the heated blade all around the core is not always correctly executed, in which case cases of partial regrowth of the cores may be found.

Such regrowth cases are detected only after the core has passed through the hide of the animal. In any event, this involves a second operation on the animal concerned, this second operation generally proving to be fairly traumatic for the animal.

A dehorning appliance described by the patent document published under the number GB 813 159 is known from the prior art, taking the general form of a gun, with a grip surmounted by a barrel having an opening through which a splayed head produced from a material able to heat up sufficiently to burn the periphery of a horn core. According to one embodiment, the electrical element extends inside the head, which forms a turn in contact with the active end of the head.

According to this prior art, it is therefore not the electric element that is directly in contact with the core, but the splayed head that is heated by the electric element. The result of this is a possible loss of thermal efficiency and/or high electrical consumption to obtain a satisfactory result in terms of burning of the core.

### SUMMARY

An exemplary embodiment of the disclosure relates to an electric dehorning appliance of the type comprising a heated element consisting of an annular heated blade forming an electrical resistance supplied by electrical supply means, the heated blade being electrically connected to the electrical supply means by a pair of electrical connection elements, characterised in that the heated blade extends in a circular fashion over 360° and is coupled to two diametrically opposed rigid electrical connection tabs.

Thus, by virtue of the invention, the simple application of the heated blade to the horn core makes it possible, in a single action, to effect a burn all around the core.

Unlike the prior art, it is not necessary to master any particular action in order to carry out dehorning effectively.

In other words, with an electric dehorning appliance according to the invention, the efficacy of the dehorning operation is appreciably improved and there is a tendency towards a result without any risk of regrowth, even partial, of the cores.

Furthermore, it should be noted that the invention proposes an electric dehorning appliance with an electric heated blade with a design that runs counter to traditional practices of producing annular heated blades. This is because the heated blade according to the invention forms a closed circle, unlike the prior art, with connection terminals providing, as will be explained in more detail hereinafter, perfect homogeneity of ohmic resistance over 360° , ensuring homogeneous burning of the core over its entire periphery.

Advantageously, the heated blade has a first phase intended to be brought in contact with a horn, and a second face opposite to the first, the connection tabs extending from the second phase.

In this way, the surface intended to penetrate the hide of the animal is restricted solely to the circle formed by the heated blade, which tends to facilitate the dehorning operation and to limit the trauma for the animal.

Advantageously, the connection tabs extend orthogonally to the points defined by the heated blade.

Preferentially, the connection tabs each have a flat portion forming a fixing interface with one of the connection elements.

According to a particularly advantageous embodiment, the circular blade and the two connection tabs are integrated in the same metal piece constituting a closed circuit, the continuity of which is free from any connection by welding.

In other words, as will be explained in more detail hereinafter, the piece including the heated element and comprising the heated blade and the connection tabs is obtained from the same metal plate and in a single piece.

The absence of any weld to close the circuit contributes to the efficacy of electric heated blade, in that no heterogeneity is introduced into the circuit with regard to the ohmic resistance liable to result, at the circle formed by the heated blade, in a difference in amperage between the two paths (half-circles) connecting the terminals (which could lead, partially, to imperfect burning and consequently to a risk of partial regrowth of the core).

In this case, the circular blade advantageously consists of two half-circles put together to form a circle, each half-circle extending between two diametrically opposed ends, each of these two ends being connected by a fold to a tab layer for connection to an identical connection tab connected by a fold to the other half-circle, the two layers being connected by a fold at their base opposite to the half-circles.

There is therefore obtained in this way a piece, including the heated blade and the connection blades, which proves to be simple in design and inexpensive to produce.

According to another advantageous feature, the flat portions are each connected to the half-circles by a connecting portion with a width less than the width of the flat portions.

Thus the portion of reduced width may advantageously constitute a folding zone facilitating the forming of the piece including the heated blade with the connection tabs.

In this case, the connecting portion preferentially has a U shape, formed by arms connected by a base, the two arms extending in a body orthogonal to the plane of the half-circles, one of the arms being connected to a half-circle and the other arm being connected to a flat portion.

According to a particular embodiment, the flat portions are offset at the side of the heated blade.

Thus the circular blade has a configuration particularly suited to the manufacturing method described below.

The invention also relates to a method for manufacturing a circular blade for a dehorning appliance as described previously, characterised in that it comprises the steps of:
cutting a closed circuit from a metal plate, the circuit having two pairs of opposite edges having symmetry about a median axis;
curved folding of a first of the pairs of edges in order to give them a semicircle shape;
folding of the other pair of edges about the median axis so as to bring the two folded parts against each other.

### BRIEF DESCRIPTION OF THE DRAWINGS

Other features and advantages of the invention will emerge more clearly from a reading of the following description of a preferential embodiment of the invention, given by way of simple illustrative and non-limitative example, and the accompanying the drawings, among which:

FIG. 1 is an overall perspective view of an example embodiment of a dehorning appliance according to the invention;

FIG. 2 is a view of a subassembly of a dehorning appliance according to the invention;

FIG. 3 is a view of a piece including the circular heated blade intended to be integrated in a dehorning appliance according to the invention;

FIGS. 4 to 7 are views of the successive steps of a piece including a circular heated blade intended to be integrated in a dehorning appliance according to the invention.

### DETAILED DESCRIPTION OF ILLUSTRATIVE EMBODIMENTS

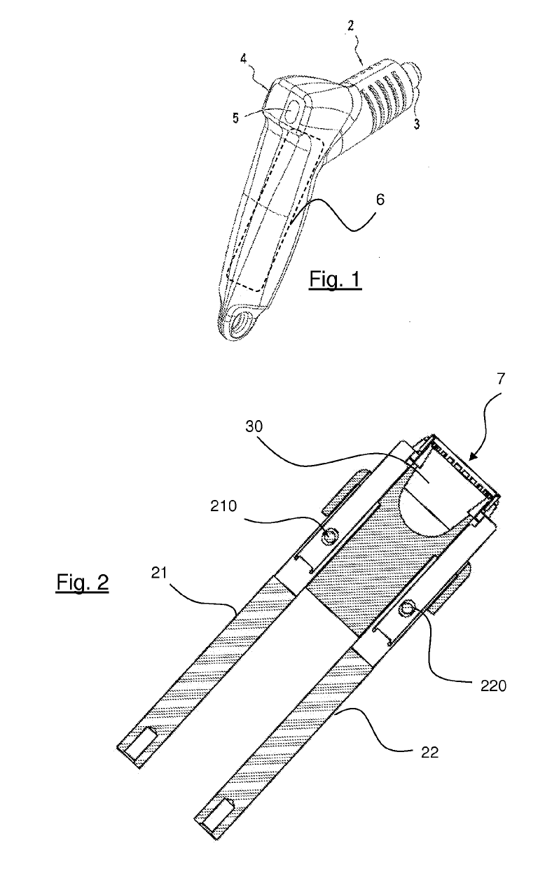

With reference to FIG. 1, a method for carrying out dehorning according to the invention is described, taking in this case an overall configuration like a gun, comprising conventionally:
a handle 1, intended to be held in the hand by the user;
a dehorning head 2, therefore forming, according to the present embodiment, an L with the handle 1 and having an end piece 3 intended to be applied to the head of a horned animal, at the precise location of a horn core.

The casing of the dehorning appliance has on its external surface a control button 5, which may of course be positioned at various points on the casing, and being intended to be actuated in order to control the electrical supply to the heated blade of the appliance.

The internal compartment of the handle 1 is intended to form a housing receiving a rechargeable battery forming electrical supply means 6 for the heated blade of the appliance. The rechargeable battery may for example be connected, by means of a connection socket, to an external electrical system, accessible through an opening flap 4 at the rear of the appliance.
It should be noted that the casing of the appliance also encloses an electronic card designed to provide regulation of the electrical supply, with a view in particular to
delivering a constant electric current to the heated blade;
optimising the capacity of the battery, in order to ensure a predetermined number of cycles (around 160 cycles) and for a relatively high current intensity (around 60 A);
controlling the cycle times;
etc.

The casing, in the part of the appliance corresponding to the dehorning head, has cooling windows, and integrates a heating body providing the electrical connection between the rechargeable battery of the appliance and the heated blade (which forms an electrical resistance).

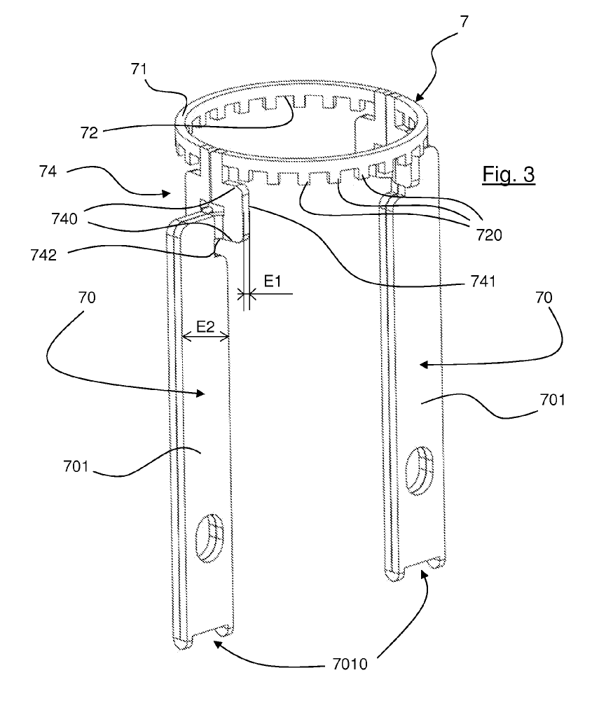

This heating body is illustrated partly by FIG. 2, comprises a pair of electrical connection elements 21, 22 connected to the two terminals of opposite polarity of the battery of the appliance.

In practice, these electrical connection elements 21 and 22 consist of electrically conductive metal rods, therefore constituting electrical supply pins for the heated blade 7 of the appliance. Thus the rechargeable battery forms electrical supply means 6 for the heated blade, which can vary according to other embodiments that can be envisaged, for example by connecting the heated blade of the appliance to an external electrical system (by means of the electrical connection elements 21 and 22).

In any event, the heated blade is electrically connected to the electrical supply means of the appliance by means of the connection tabs, so that the heated blade forms, with the connection tabs, a portion of an electrical circuit.

The electrical connection elements 21, 22 each have a split end, the corresponding shape forming a housing in which a flat portion of the electrical connection tabs to which the heated blade is coupled is intended to be embedded.

Moreover, as is clear in FIG. 2, the heated blade 7 is supported by a support 30, preferably made from ceramic, on either side of which the connection tabs 70 extend, coupled to the heated blade 7. The assembly containing the support, the connection tabs and the heated blade form the previously mentioned end piece 3.

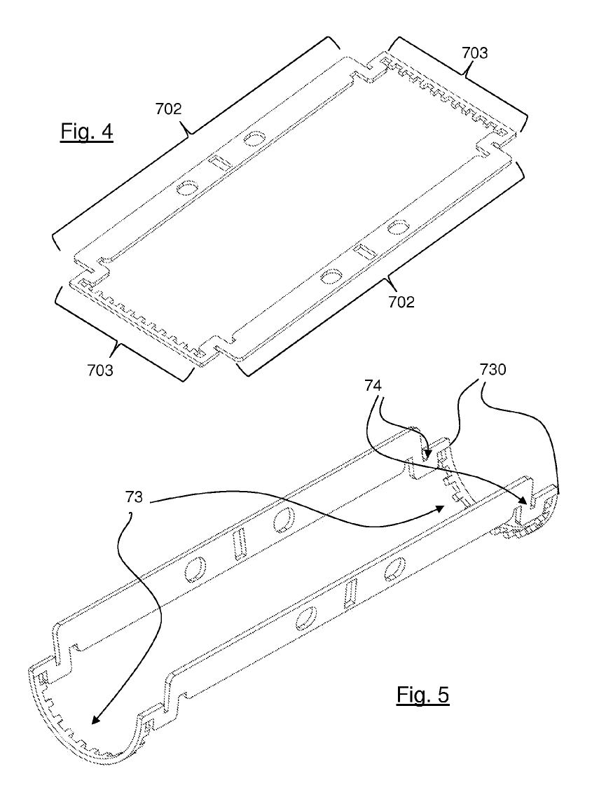

According to the principle of the invention, the heated blade 7 extends in a circular fashion over 360° (FIG. 3) and is coupled to two rigid electrical connection tabs 70, diametrically opposed with respect to the circle of the heated blade.

As illustrated by FIG. 3, the heated blade has a first face 71 intended to be brought in contact with a horn and a second face 72, opposite to the first, from which the connection tabs 70 extend, orthogonally to the plane defined by the heated blade 7.

According to the present embodiment, a plurality of evenly distributed lugs 720 extend from the face 72 and orthogonally to the face defined by the latter.

The number and dimensions may vary as required. Their function is to optimise the diffusion of heat, by optimising the distribution of heat over the 360° of the heated blade.

As is clear in FIG. 3, the connection tabs each have a flat portion 701 forming a fixing interface with one of the connection elements 21, 22.

As is clear in FIGS. 3 and 7, the flat portions 701 each have at their base a recess 7010, intended to facilitate the folding carried out during the process of manufacturing the heated blade described hereinafter.

Thus, as mentioned previously, the connecting elements 21, 22 have a slot at their end, the flat portions have a thickness identical, to within any clearance, to the internal space of each slot. The flat portions therefore come to be embedded in the slot and are fixed therein by means of screws 210, 220.

Naturally, this connection by screwing allows the removable mounting of the end piece 3, allowing replacement thereof in the event of wear and/or damage.

In addition, it will be noted that the connection lugs, and in particular the flat portions 701 of the connection lugs, extend at the side of the heated blade. In other words, if the perimeter of the heated blade 7 is projected along the central axis of the circle of the heated blade, the flat portions 701 extend outside the perimeter of this projection, in a diametral plane of the heated blade.

The result of this configuration is that the end piece 3 on which the heated element is mounted can be produced in a relatively simple form.

According to an advantageous feature of the invention, the heated blade and the two connection tabs are integrated in the same metal part constituting a closed circuit, the continuity of which is free from any connection by welding.

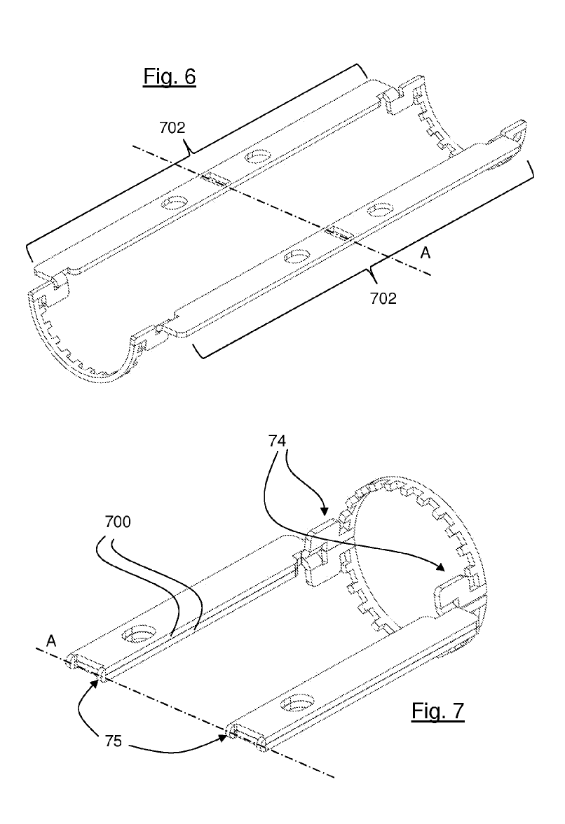

To do this, according to the present embodiment, the heated blade 7 consists of two half-circles placed together through their diametrically opposed ends in order to constitute a circle. Furthermore, each end of the half-circles is connected to a layer of connection tabs, up against, as will be explained hereinafter with reference to FIGS. 4 to 7, another identical layer of connection tabs connected to the half-circle, the two layers being connected at their opposite bases to the half-circle by a fold.

In this way a continuous closed circuit is obtained, in a single piece, according to a method described below.

With reference to FIG. 4, a closed circuit, consisting mainly of four sides distributed in two pairs of opposite sides, in this case a pair of “large sides” 702 and a pair of “small sides” 703, are cut for example by means of a hollow-punch cutting die.

It should be noted that the closed circuit produced has symmetry about a median axis.

As illustrated by FIG. 5, the initially flat metal circuit is rolled on a half-cylinder so as to form two end half-circles 73.

As illustrated by FIG. 6, the “large sides” 702 are folded over by folding at 90° towards the outside of the closed circuit.

Next, as illustrated by FIG. 7, the “large sides” 702 are folded about the median axis A, until the two folded parts of the “large sides” are brought one against the other. With reference to what was described previously, each half of the large sides 702 thus constitutes a layer of connection tabs.

Moreover, as is clear in FIG. 3, the flat portions 701 are each connected to the half-circles by a connecting portion 74, the width El of which is appreciably less than the width E2 of the flat portions. This assists the formation of the heated element by the folding technique described previously with reference to FIGS. 4 to 7.

More precisely, the connecting portions 74 each have a U shape, this U consisting of two arms 740 connected by a base 741. The two arms 740 of the connecting portion extend in a plane orthogonal to the plane of the half-circles, one of the arms 740, in an upper position, being connected to one half-circle, while the other arm, in the lower position, is connected to a flat portion 701 of the connection tab, by means of a fold 742. Thus each end 730 of the half-circles (these ends therefore being diametrically opposed) is connected to a layer of connection tabs by a connecting portion 74.

Each half of the large sides 702, each constituting one of the two layers 700 (FIG. 7) constituting in the end a flat portion of the connection tabs, therefore extends between a connecting portion 74 and a fold 75, connecting the two layers 700, present at the base of the two layers situated opposite the half-circles.

An exemplary embodiment of the present disclosure overcomes the drawbacks of the prior art.

An exemplary embodiment proposes an electric dehorning appliance that guarantees the elimination of each horn core treated, without risk of regrowth or almost so, this without its being necessary for the user to master any action.

An exemplary embodiment provides such a dehorning appliance that can be offered in a portable electrical version.

An exemplary embodiment provides such a dehorning appliance that is inexpensive to produce.

An exemplary embodiment proposes a method for manufacturing a heated blade for a dehorning appliance according to the invention.

1. An electric dehorning appliance, comprising:
an electrical supply; and
a heating element comprising an annular heating blade forming an electrical resistance to an electric current supplied by the electrical supply means, the heating blade being electrically connected to the electrical supply by a first and second electrical connection elements, and wherein the heating blade extends in a circular fashion over 360° and is coupled to first and second diametrically opposed rigid electrical connection tabs.

2. The electric dehorning appliance according to claim 1, wherein the heating blade has a first face intended to be brought in contact with a horn, and a second face opposite to the first face, the connection tabs extending from the second face.

3. The electric dehorning appliance according to claim 1, wherein the connection tabs extend orthogonally to the plane defined by the heating blade.

4. The electric dehorning appliance according to claim 1, wherein the connection tabs each have a flat portion forming a fixing interface with one of the connecting elements.

5. The electric dehorning appliance according to claim 1, wherein the heating blade and the first and second connection tabs are integrated in a same metal piece constituting a closed circuit, wherein a continuity of which is free from any connection by welding.

6. The electric dehorning appliance according to claim 5, wherein the heating blade is formed by two half-circles put together to form a circle, each half-circle extending between two diametrically opposed ends, each of these two ends being connected to a layer of connection tabs put against an identical layer of connection tabs connected to the other half-circle, the two layers being connected by a fold at their base opposite to the half-circles.

7. The electric dehorning appliance according to claim 6, wherein the connection tabs each have a flat portion forming a fixing interface with one of the connecting elements, and the flat portions are each connected to the half-circles by a connecting portion with a width less than the width of the flat portions.

8. The electric dehorning appliance according to claim 7, wherein the connecting portion has a U shape, comprising first and second arms connected by a base, the first and second arms extending in a plane orthogonal to a plane of the half-circles, one of the first and second arms being connected to a respective half-circle and the other of the first and second arms being connected to a respective flat portion.

9. The electric dehorning appliance according to claim 4, wherein the flat portions are offset to the side of the heating blade.

10. A method of manufacturing a circular blade for a dehorning appliance, the method comprising:
cutting a closed circuit from a metal plate, the circuit having two pairs of opposite edges having symmetry about a median axis;
curved-folding a first pair of the edges in order to give them a semicircle shape;
folding the second pair of the edges about the median axis so as to bring a first folded part of each of the second pair of edges against a second folded part of each of the second pair of edges, thereby forming a heating element comprising an annular heating blade formed by the first pair of edges, wherein the annular heating blade extends in a circular fashion over 360° and is coupled to the second pair of edges, which form first and second diametrically opposed rigid electrical connection tabs; and
electrically connecting the first and second electrical connection tabs to an electrical supply such that the annular heating elements form an electrical resistance to an electric current supplied by the electrical supply.
